(19) United States
(12) Patent Application Publication
(10) Pub. No.: US 2024/0017668 A1
(43) Pub. Date: Jan. 18, 2024

(54) LIGHTING DEVICE FOR A MOTOR VEHICLE

(71) Applicant: Lisa Draexlmaier GmbH, Vilsbiburg (DE)

(72) Inventors: Alexandr ZAVIYALOV, Vaterstetten (DE); Michael WINDL, Landshut (DE)

(73) Assignee: Lisa Draexlmaier GmbH, Vilsbiburg (DE)

(21) Appl. No.: 18/476,020

(22) Filed: Sep. 27, 2023

Related U.S. Application Data
(63) Continuation of application No. PCT/EP2022/056510, filed on Mar. 14, 2022.

(30) Foreign Application Priority Data
Apr. 1, 2021 (DE) 102021108391.5

(51) Int. Cl. B60Q 3/283; B60Q 3/64; B60Q 3/82; F21V 8/00

(52) U.S. Cl. CPC B60Q 3/283; B60Q 3/64; B60Q 3/82; G02B 6/0063

(57) ABSTRACT

A lighting device for a motor vehicle includes a light guide body having a first outer surface free from a dedicated light decoupling structure, and a second outer surface, in which the outer surfaces are spaced from each other by a thickness of the light guide body. On the light guide body, a light coupling surface and a light decoupling region are provided by a dedicated light decoupling structure being formed on the second outer surface. The light decoupling structure includes a light decoupling element. When in an illuminated operating mode, the light decoupling region is an opaque region of the light guide body, inhibiting the visibility of a portion of a design element for a human viewer, and in a non-illuminated operating mode the light decoupling region is a transparent region of the light guide body, permitting the visibility of a design element for a human viewer.

### CROSS-REFERENCE TO RELATED APPLICATIONS

This application is a continuation of International Application No. PCT/EP2022/056510, filed on Mar. 14, 2022, which claims priority to and the benefit of DE 102021108391.5 filed on Apr. 1, 2021. The disclosures of the above applications are incorporated herein by reference.

### FIELD

The present disclosure relates to a lighting device that includes at least one light guide body with a light decoupling region.

### BACKGROUND

The statements in this section merely provide background information related to the present disclosure and may not constitute prior art.

Light guides with light decoupling elements are already known from the prior art. For example, light guides are used in the interior of motor vehicles, and/or as part of an external lighting system of motor vehicles, such as for ambient lighting or for the illuminating of operating elements. Furthermore, it is known to use light guides as design elements. For the decoupling from the light guide of at least one part of the light coupled into the light guide, light decoupling elements are used that are to provide a pleasant, homogeneously distributed light with the use of further optical element (for example, white reflectors, diffusing lenses, etc.)

Diffusing lenses are usually disposed between a viewer of the light guide and the light guide. A diffusing lens on the one hand inhibits direct, sharp, or faithful recognition of the light guide disposed below the diffusing lens, or individual decoupling elements thereof. On the other hand, a diffusing lens enlarges and redirects a main direction of the light decoupled from the light guide, which is typically only about 40 degrees relative to an exit surface of the light guide onto a viewing region that is clearly observable from typical viewer positions. This viewing region is usually located in a range of 65 degrees to 90 degrees relative to a light exit surface of the light guide. The diffusing effect of the diffusing lens is thus used to redirect light rays coupled or occurring in the light guide such that the viewer recognizes the light from the typical viewer positions as homogeneous or uniform light.

Diffusing lenses also convert the mostly heterogeneous light/luminous image of the conventional light guide into a homogeneous light/luminous image. For this purpose diffusing lenses are configured milky or only diffusely translucent, and consequently are not transparent in a manner faithful to the image. This means that contours (i.e., structures, shapes, symbols, characters, etc.) that are disposed below the conventional light guide, and thus below the diffusing lens, are not clearly recognizable for the human viewer using the physiology of the human body. In any case the contours appear as diffuse, contour-less shadow images. This applies for an illuminated operating mode and for a non-illuminated operating mode of the light guide. In the non-illuminated operating mode of the light guide, the diffusing lens appears to the viewer as an opaque, for example, grey or white, object.

### SUMMARY

This section provides a general summary of the disclosure and is not a comprehensive disclosure of its full scope or all of its features.

The present disclosure provides a lighting device in which in a non-illuminated or deactivated operating mode, a contour covered by a light guide of the lighting device is clearly/sharply or faithfully visible for a human viewer without aid. In one form, the present disclosure provides using the lighting device with at least two appearances recognizable for a user.

A lighting device is provided for a motor vehicle, that can be for an interior of a motor vehicle in one form, in which the motor vehicle can be an automobile. The lighting device includes a light guide body that includes a first outer surface configured as useful-light exit surface, and a second outer surface. Here the first outer surface or the useful-light exit surface is free from a dedicated light decoupling structure. In a manufacturing of the first outer surface, no step occurs in order to confer to the first outer surface a refractive and/or light-deflecting functionality or property for the decoupling of light from the light guide body. It can be provided that during the manufacturing of the first outer surface, a step is taken to remove from the first outer surface a refracting and/or light-deflecting functionality or property for the decoupling of light from the light guide body.

The first outer surface and the second outer surface are spaced from each other by a thickness or gauge of the light guide body. In addition, the light guide body includes a light coupling surface configured differently from the outer surfaces, in which the light coupling surface is a further outer surface of the light guide body. For example, it can be provided here that the third outer surface or the light coupling surface is disposed perpendicular to the first outer surface and/or to the second outer surface.

The light guide body further includes a light decoupling region in which a dedicated light decoupling structure is formed on the second outer surface, where the light decoupling structure includes at least one light decoupling element. In one form, it can be provided that the light decoupling region includes a variety of light decoupling elements, or is formed by a variety of light decoupling elements. Here the light decoupling region is provided such that in an illuminated operating mode—when light is coupled into the light guide body via the light coupling surface—the light decoupling region is an opaque region of the light guide body, and in a non-illuminated operating mode—when no light is coupled into the light guide body via the light coupling surface—the light decoupling region is a transparent region of the light guide body. Here the measure of the transparency (transparent or opaque) is based on an average and healthy human viewer whose human viewing apparatus is located at an average viewing distance region for the lighting device. For example, the viewer has assumed a corresponding viewing distance of the viewing distance region by sitting in an intended manner on a seat of the motor vehicle, for example, as driver or passenger or (back-seat) passenger. Here possible adjustment options of the seat are taken into account. For example, a possible viewing distance from the average viewing distance region can be 20 centimeters or more.

Whether the light guide body is represented for the viewer as transparent or opaque depends on the one hand whether the light guide body is operated in the non-illuminated operating mode or illuminated operating mode. In addition, a distribution density of the light decoupling elements plays a role. With reference to the average viewing distance region, the light guide body, in particular its light decoupling structure, has a distribution density of the light decoupling elements such that in the illuminated operating mode they are no longer recognizable resolved as individual (light) points by the human eye. In other words, the average physiological human viewing apparatus is not able to optically resolve the light decoupling structure sufficiently to distinguish a single one of the light decoupling elements from another light decoupling element of the same light decoupling structure; to the human, the light decoupling elements of the light decoupling structure appear as a continuous and in particular homogeneous surface. In this regard, the light decoupling structure of the light guide includes the light decoupling elements, in which the distribution density (ratio of a number of light decoupling elements in relation to a surface of the second outer surface) is chosen and/or configured such that—at least in illuminated operation—the human viewer perceives the light decoupling structure as the continuous surface, since a single one of the light decoupling elements is not recognizable by itself. For example, the light decoupling structure can include a uniform or nonuniform grid made of light decoupling elements. Thus, for example, that 9, 16, 25, etc. light decoupling elements are formed per square millimeter. Here the light decoupling elements can be disposed equidistant or at irregular intervals with respect to each other: 3×3, 4×4, 5×5, etc. Other arrangements of the light decoupling elements are also possible, approximately four light decoupling elements that lie at corners of a square, and one that lies in the middle of the square, so that in this case 5 light decoupling elements are available per square millimeter. Furthermore, arrangements are possible in which the light decoupling elements are disposed unevenly, for example, according to an uneven curve, according to a circle, etc.

“Transparent” is to be understood to mean herein that the human viewer can clearly recognize specifically a structure, in particular a design element, disposed below the light guide body. Nevertheless, due to the light decoupling structure, which is disposed in the viewing direction between the eyes of the view and the structure or the design element, a slight haze can be perceived through which the viewer recognizes the structure. The haze therefore does not counter an image fidelity or border fidelity of the design element that the viewer recognizes. In other words, the light decoupling structure or the light decoupling elements are configured such that the possibly associated haze does not hinder too greatly the clear recognition of the design element.

With this lighting device, there is now the possibility to provide a first appearance, corresponding with the illuminated operating mode (when light is coupled into the light guide body via the light coupling surface), of the lighting device, and a second appearance, different therefrom, corresponding with the non-illuminated mode (when no light is coupled into the light guide body via the light coupling surface), of the lighting device. Because in the illuminated operating mode (which can also be called the hot state) the first appearance, corresponding with the illuminated operating mode, is presented by at least the light decoupling region of the lighting device or of the light guide body appearing opaque. In contrast, in the non-illuminated operating mode (which can also be called the cold state) of the lighting device, the second appearance is presented, in which at least the light decoupling region of the lighting device or of the light guide body appears transparent. In other words, the first appearance of the lighting device or the second appearance of the lighting device is activatable depending on which of the operating modes the lighting device is switched into. A variety of possibilities is thereby provided to use the lighting device—beyond a pure lighting functionality—for example by the viewer of the lighting device, which can be, for example, a user, or in one form, a driver, of the motor vehicle, being provided different functionalities, for example, of the motor vehicle, depending on the active appearance.

The lighting device is thus configured such that a contour, which is disposed below the light guide body, is clearly recognizable for the human viewer by the physiological human viewing apparatus without aid external to the human body. For this purpose, no dedicated opaque light diffusing element—in one form no diffusing lens—is disposed in the viewing device, and in another form, the diffusing lens is on the side of the first outer surface. In other words, according to a further variation of the lighting device, the lighting device is disposed between the human viewer and the light decoupling device free of a light diffusing element or free of a diffusing lens. In this regard, the desired free, clear, and sharp view of the human viewer through the light guide body onto elements, structures, contours, etc. that are disposed in the viewing direction behind the light guide body is further promoted.

According to the present disclosure, the lighting device further includes a design carrier which includes a design surface. Here, the second outer surface of the light guide body and the design surface of the design carrier are facing each other. On/against the design surface, a design element or a variety of design elements is disposed or configured so that the respective design element and the second outer surface of the light guide body are facing toward each other. This means that the light guide body is disposed between the design carrier and the human viewer, or between the respective design element and the human viewer, in which the respective design element is completely or partially covered by the light decoupling region. In other words, and in relation to the viewing direction of the human viewer, the design carrier is therefore disposed below the light guide body, whereby the design element or the design elements is or are disposed below the light guide body. It then applies for the illuminated operating mode of the lighting device that a portion of the design carrier covered by the light decoupling region, in particular, a portion of the design surface is not visible for the human viewer at least through the light decoupling region, whereas in the non-illuminated operating mode of the lighting device the portion of the design carrier covered by the light decoupling region, in particular the corresponding portion of the design surface, is visible for the human viewer through the light decoupling region. Accordingly, with active night appearance of the lighting device, the respective design element is completely or partially invisible for the human viewer due to the light-emitting light decoupling region, depending on whether the corresponding design element is covered by the illuminating light decoupling region. However, in the day appearance of the lighting device, the corresponding design element with non-illuminating light decoupling region is visible for the human viewer through the light decoupling region. This means that the first appearance of the lighting device is characterized in that the design carrier is not visible in the light decoupling region of the light guide body, whereas the second appearance of the lighting device is characterized in that the design carrier is visible through the light decoupling region for the human viewer.

The design carrier, in particular a portion of the design carrier that is visible through the light decoupling region in the non-illuminated operating mode of the lighting device—for example, the design surface of the design carrier—can be, for example, a purely decorative design element. This means that the design carrier as design element can be coated decoratively in/on the portion corresponding to the light decoupling region, for example the design surface, and/or include a decorative surface structure. Furthermore, it is possible that the design carrier, in particular the design surface, is provided with, alternatively or in addition to the decorative function as design element, characters, text, numbers, symbols, etc., and thus, at least in night illumination operation of the lighting device, provides corresponding information to the human viewer. Furthermore, it is possible that the human viewer is provided with corresponding information by the portion provided with the characters or the corresponding design element of the design carrier being at least partially hidden for the human observer in the illuminated operating mode of the lighting device by light being coupled into the light guide body via the light coupling surface.

For these purposes the design carrier, in particular its design surface, can be configured in the widest variety of designs, whereby the design carrier itself forms the design element, and/or includes the widest variety of design elements. For example, the design carrier is formed in any color. For this purpose, the design carrier can be formed from a correspondingly colored or dyed material, in particular cast. Alternatively or additionally, the design carrier can be coated completely or partially with a corresponding color carrier. For example, the design carrier or the design surface can be coated with a lacquer, such as, but not limited to, metallic lacquer, effect lacquer, chrome lacquer, etc. Here—optionally multiple—spraying/spraying-on, transfer roll lacquers, painting/painting-on, etc. can be considered. Powder coating, high-gloss finishing, etc. is also possible. Furthermore, the design carrier as design element can be coated completely or partially with a clear lacquer. Furthermore, the color carrier or the design element can be formed as a foil, so that the color carrier has been applied to the design carrier, for example, onto the design surface, by the design carrier being foil-coated.

During the casting of the design carrier, the design carrier can be given a desired structure so as the design element is visible for the human viewer through the illumination body in night illumination operating mode or day appearance of the lighting device. Thus, it is possible to form the design carrier, at least its design surface, as a visible carbon part in which the carbon fiber surface has not been coated or has only been coated with a clear agent. The visible carbon part is then the design element. Further visible 3D structures are possible as design element, for example, a crystal- or diamond-type visual structure, other grains, etc.

The design surface of the design carrier can furthermore be printed and/or painted with the characters, text, numbers, symbols, etc. In any case, in the lighting device it is provided that the design carrier is distinguished from a pragmatically designed component that does not include a dedicated, specific design element, and appears, for example, simply flat and simply white. It is to be understood in one form the design carrier is not an optical reflector (for example, mirror, etc.)

In an alternative design, the lighting device is formed without a design carrier. This means that the design carrier, and consequently the design element/the design elements are then not part of the lighting device. Instead, in the non-illuminated operating mode, the lighting device, in particular the light guide body, unblocks the view for the human observer of a structural element, disposed below the light guide body, at the installation location or of the installation location of the lighting device. In a corresponding manner, in the illuminated operating mode the structural element is hidden for the human viewer. Here the structural element is not part of the lighting device, but rather, for example, part of the motor vehicle in which the lighting device is used.

In this context, it is provided in one form, the second outer surface and the design surface are spaced from each other by a spacing of up to 100 millimeters. In another form, the spacing by which the second outer surface of the light guide body and the design surface are spaced from each other is 0.3 millimeter to 100 millimeters, in one form, 1 millimeter to 10 millimeters. It is advantageous with such a spacing that contours disposed below the light guide body, in particular contours, for example, the design elements of the design carrier, are particularly, clearly, or sharply recognizable through the light decoupling region of the light guide body when no light is coupled into the light guide body via the light coupling surface. A desired spacing between the second outer surface and the design surface is directly associated with the arrangement density of the light decoupling elements, which are described in more detail below. The lower the arrangement density of the light decoupling elements is, the greater the spacing can be selected between the second outer surface and the design carrier or the design surface, in which the contour disposed below the light guide body is still perceived as clear or sharp for the human viewer. This means that for the spacing between the second outer surface and the design surface it generally applies that the spacing can be chosen depending on the arrangement density of the light decoupling elements.

According to a further development of the lighting device, it is provided that the spacing between the second outer surface and the design surface varies along a width direction and/or along a depth direction of the light guide body or the lighting device. This results in even more design possibilities for the lighting device.

According to a further design, the lighting device includes a user interaction unit that includes the light decoupling region as a user interaction region. For example, the light decoupling region or the user interaction region can be a touch-sensitive button, for example, a capacitive button, in which it can then be provided in one form, that the button or the light decoupling region provides a corresponding switching functionality depending on the active appearance. Furthermore, it is possible that the light decoupling region in connection with the user interaction unit serves as a display element for the user or viewer. Depending on the active appearance of the lighting device, a status, a warning etc. is providable to the viewer or user via the light decoupling region. Thus, a particularly conspicuous user interaction unit is provided that is particularly reliably perceived by the user or viewer in an advantageous manner.

In a further design of the lighting device, an outer contour of the light guide body has a flat design, i.e. a flat outer contour. In other words, the light guide body defines a flat outer contour. This means—with respect to an installation position of the light guide body—a width or depth of the light guide body is greater than a thickness or gauge of the light guide body. For example, it can be provided that the light guide body is formed square-shaped, in which the first outer surface and the second outer surface of the light guide body are each flat and disposed parallel to each other. However, it is also possible that the light guide body has an outer design that is formed corresponding to any polyhedron, in one form, a prism. Furthermore, the outer design can be formed corresponding to a general cylinder. In addition, mixed shapes with at least one prismatic portion and/or at least a cylindrical portion are possible.

The flat outer contour of the light guide body makes possible a particularly space-economically configured lighting device that in particular requires particularly little installation space depth, whereby a concept of a particularly advantageous packaging, in one form in automobile manufacturing, is notably taken into account.

According to a further design of the lighting device, the light guide body includes a clear region delineated by the light decoupling region, of which the clear region is free from a light decoupling structure. This means that in the illuminated operating mode of the lighting device, the light coupled into the light guide body via the light coupling surface is transmitted into the clear region inside the light guide body by total reflection in the light guide body, and does not exit from the light guide body via the clear region or in the clear region. This means that due to the clear region, the lighting device includes a region that appears as transparent regardless of the respective active appearance for the viewer. In a manufacturing of the clear region, no step is taken to confer to the clear region a refractive and/or light-deflecting functionality or property for the decoupling of light from the light guide body. It can be provided that in the manufacturing of the clear region, a step is taken to remove from the clear region a refractive and/or light-deflecting functionality or property for the decoupling of light from the light guide body. In this way, still further possibilities arise to design the respective appearance that corresponds to the illuminated operating mode or the non-illuminated operating mode, by combining a light decoupling region or a plurality of light decoupling regions and a clear region or a plurality of clear regions with one another.

In this context, it is provided, in one form, the light decoupling region and the clear region are sharply delimited from each other at least regionally. Alternatively or additionally, in this context it can be provided that the light decoupling region and the clear region seamlessly merge into each other at least regionally, that is they have no sharp boundary between each other. If the light decoupling region or the light decoupling regions and the clear region or the clear regions are sharply delineated from one another, it is possible, for example, that in the illuminated operating mode of the lighting device, the respective light decoupling region appears to the user as a touch-sensitive keypad region. If the light decoupling region and the clear region seamlessly merge into each other, for example, by an arrangement density of the light decoupling elements starting from an edge of the lighting device decreasing toward an interior of the lighting device, a particularly advantageous ambient lighting and/or contour lighting arises of the lighting element. For the viewer, for example, a course of visibility or invisibility of the portion of the design element or of the design elements covered by the light decoupling structure arises in accordance with a course of the seamless transition between the clear region and the light decoupling region.

According to a further variation of the lighting device, a transparent cover element is provided that on the side of the first outer surface is disposed facing the light guide body, and is free from a dedicated light decoupling structure. Thus, the transparent cover element is ideally configured completely transparent or completely transparent in an image-faithful manner, and forms, for example, a protective element for the light guide body of the lighting device. In a manufacturing of the cover element, no step is taken to confer to the cover element a refractive and/or light-deflecting, i.e., a light-diffusing, functionality or property. It can be provided that in the manufacturing of the cover element, a step is taken to remove a light-diffusing functionality or property from the cover element. In one form, when it is provided that the lighting device is touched by the viewer or user, for example, in the context of a user interaction, it is thus effectively prevented that the user or viewer directly touches and consequently possibly damages the light guide body.

An optional tinting of the cover element, for example, with a tinting degree of up to 70% (in particular 30% to 70%), does not counter the image-faithful transparency of the cover element. The degree of tinting is in one form is chosen such that at least in the non-illuminated operating mode or in the active day appearance, the human viewer can recognize, in outline terms, the design element, that is, the design surface of the design carrier. It is thereby made possible, for example, that the cover element in the day appearance image is represented as a darkened but transparent “black panel.”

In general, it can be provided in the lighting device that more than just a single light guide body is used. This means that the lighting device can generally include a variety of light guide bodies, which are disposed, for example, adjacent to one another in a common plane. In order to avoid that dirt, for example, dust, unwanted liquids, crumbs, etc., get directly onto the respective light guide body and/or between the light guide bodies, the transparent cover element can cover the light guide body of the lighting device in a one-piece manner, whereby it can be effectively prevented that dirt gets into the lighting device in an undesired manner. It is possible here that the design carrier includes the cover element. For this purpose, the cover element and the design carrier can be connected to each other in a friction-fit, interference-fit, and/or material-bonded manner, for example, adhered. Alternatively or additionally, the cover element and the design carrier can be formed one-piece with each other. Here the design carrier and the cover element can be comprised of different materials. The cover element and/or the design carrier can be manufactured, for example, using a generative manufacturing process (for example, 3D printing).

In a further design of the lighting device, viewed in cross-section the respective light decoupling element includes at least one pitch-circle-shaped tip region, a first linear region connected to the tip-shaped region, and a second linear region connected to the first linear region. Viewed three-dimensionally, this means that the respective tip region of the respective light decoupling element has the shape of a spherical calotte or spherical cap.

Overall, a decoupling of the light is thereby achieved that approaches in an angular range of 65 degrees of 90 degrees with respect to the first outer surface of the light guide body. Accordingly, a light decoupling element designed in such a manner supports the omission of an opaque or milky light diffusing element, for example, a diffusing lens.

In general, the light decoupling structure includes at least one light decoupling element, that is, the light decoupling structure, in one form, includes a variety of light decoupling elements that can be arranged with respect to each other according to a regular pattern and/or chaotically. A radius of the respective splitting pitch-circle-shaped tip region lies in a range between 0.03 millimeter and 0.3 millimeter, for example, approximately 0.1 millimeter. It can also be provided that the light decoupling elements of the light decoupling structure are not uniformly designed, but rather have different designs. Furthermore, it is possible that spacings between the light decoupling elements are varied, thus, for example, the spacings between the light decoupling elements become smaller with increasing distance from a light source. That is, the arrangement density of the light decoupling elements increases. Alternatively, or additionally, it is possible that the size, in particular the height, of the light decoupling elements increases with increasing distance from the light source.

According to a further development of the lighting device, the first linear region of the respective light decoupling element includes a first incline with respect to the second outer surface of the light guide body, wherein the second linear region of the respective light decoupling element has a second incline different from the first incline. Here, it is provided in one form that a first inclination angle characterizing the first incline, which first inclination angle is enclosed by the first linear region and the second outer surface of the light guide body, is smaller than a second inclination angle characterizing the second incline, which second inclination angle is enclosed between the second linear region and the second outer surface of the light guide body. Here the first inclination angle is, for example, 50 degrees, whereas the second inclination angle is, for example, 55 degrees.

Due to the second linear region with an incline with respect to the second outer surface of the light guide body, which incline is different, in one form larger than, the first linear region, the light decoupling can be further improved in comparison to a single linear region with only a single incline.

Furthermore, the respective light decoupling element can include a third linear region with a third incline, different from the first incline and from the second incline, with respect to the second outer surface of the light guide body. Here the third linear region is connected to the second linear region, wherein the first linear region is connected to the second linear region. This means that the second linear region is disposed between the first linear region and the third linear region. Here a third angle of inclination, characterizing the third incline of the third linear region, which third angle of inclination is disposed between the third linear region and the second outer surface of the light guide body, is, for example, 60 degrees. This means that the third incline is greater than the second incline and greater than the first incline. Due to the third linear region with an incline different from the second incline and from the first incline, the light decoupling from the light guide body or from the light decoupling region can be improved even further, so that a homogeneous-as-possible light function arises in the desired region.

It can also be provided that a height of the pitch-circle-shaped or spherical-calotte-shaped tip region is greater than a height of the first linear region. In particular, the height here of the first linear region is less than a height of the second linear region. Furthermore, in one form, a height of the second linear region is less than a height of the third linear region. Here “height” is understood as a dimension that extends perpendicularly from the second outer surface of the light guide body.

For example, the height of the pitch-circle-shaped or spherical-calotte-shaped tip region is in a range between 0.01 millimeter and 0.05 millimeter. Here, in one variation, the height of the first linear region is half as great as the height of the pitch-circle-shaped tip region. Thus, the height of the first linear region, for example, is between 0.005 millimeter and 0.05 millimeter. The height of the second linear region can be greater than the height of the first linear region and less than the height of the pitch-circle-shaped tip region. In one form, the height of the second linear region is in a range between 0.01 millimeter and 0.05 millimeter. Here the height of the third linear region can be twice as high as the height of the second linear region. In one variation, the height of the third linear region is between 0.01 millimeter and 0.1 millimeter. With the specified height ratios, a particularly homogeneous light decoupling is achieved from the light decoupling region of the light guide body.

In a further design of the lighting device, the dedicated light decoupling structure includes at least one light decoupling element or a plurality of light decoupling elements, wherein starting from the second outer surface of the light guide body, the respective light decoupling element extends into the light guide body as material-free region. In simplified terms, the respective light decoupling element here is a blind hole that is formed in the light guide body starting from the outer surface of the light guide body. When the light guide body of the lighting device only includes light decoupling elements protruding into the light guide body, a flat or planar outer contour of the light guide body without projecting elevations arises in an advantageous manner.

Alternatively or additionally, the dedicated light decoupling structure can include at least one light decoupling element that protrudes outward from the second outer surface of the light guide body. This means that the light decoupling structure can on the one hand include only light decoupling elements extending into the light guide body. Furthermore, it is possible that the light decoupling structure only includes light decoupling elements projecting from the outer surface. In addition, it is possible that the light decoupling structure includes both light decoupling elements extending into the light guide body, and light decoupling elements projecting from the second outer surface of the light guide body.

According to a further design of the lighting device, the respective light decoupling element is formed symmetric, in one form, rotationally symmetric and/or planar-symmetric or mirror-symmetric with respect to a symmetry element disposed perpendicular to the second outer surface. The symmetry element or the symmetry axis and/or the symmetry plane extend/extends through a point of the respective light decoupling element, which is disposed as far as possible from the second outer surface of the light guide body. For example, the symmetry axis extends centrally through the spherical-calotte-shaped tip region. In the case of a symmetry plane, the spherical-calotte-shaped tip region is divided by the symmetry plane into tip-partial-regions formed mirror-symmetric.

Due to the symmetry of the respective light decoupling element, a symmetric angle function of the decoupled light with respect to the symmetry element is supported, whereby the angle function of the decoupled light is independent of a propagation direction of the light in the light guide body. Thus, the light decoupling element includes a first partial region with a spherical structure (due to the pitch-circle-shaped or spherical-calotte-shaped tip region) and a second partial region with a conical structure (due to the linear regions). In the spherical structure, the main direction of the decoupled light from the light guide body is strongly dependent on the propagation direction of the light in the light guide, whereas in the conical structure sharp intensity jumps and a high asymmetry are obtained. Due to a corresponding combination of the two partial regions, in the light guide body a homogeneous light function is made possible in the desired angle range (65 degrees to 90 degrees relative to the first outer surface of the light guide body).

In the respective light decoupling element, it can also be provided that the first linear region is connected to the second linear region via a first pitch-circle-shaped connecting region, wherein the second linear region is connected to the third linear region via a second pitch-circle-shaped connecting region. Furthermore, the third linear region can be connected to the second outer surface of the light guide body via a third pitch-circle-shaped connecting region.

Due to the pitch-circle-shaped connecting regions, which each connect two linear regions or one linear region to the second outer surface of the light guide body, a soft transition can be provided between the adjacent linear regions, that is, between the first linear region and the second linear region, as well as between the second linear region and the third linear region, and/or between the third linear region and the second outer surface of the light guide body. These soft transitions make possible a particularly homogeneous radiating of the light. Here the first pitch-circle-shaped connecting region and the second pitch-circle-shaped connecting region are, for example, equally large. Furthermore, it can be provided that the radius of the first pitch-circle-shaped connecting region and the radius of the second pitch-circle-shaped connecting region is between 0.15 millimeter and 0.25 millimeter, for example, 0.2 millimeter.

The design possibilities described herein of the light decoupling structure are to be understood as merely exemplary. It is possible that alternatively or in addition to the design possibilities described herein of the light decoupling structure, the light decoupling structure is formed differently, for example, of another design and/or of another type.

In general, at least in the non-illuminated operating mode of the lighting device, the light guide body is a transparent body, that can be manufactured, for example, from plastic, for example, epoxy resin, a polycarbonate (PC), a polymethyl methacrylate (PMMA), an acrylic nitrile-butadiene styrene, (ABS), a silicone, etc. Furthermore, the light guide can be manufactured from glass. The light guide body can be, for example, a rod light guide or a flat light guide. If the light guide body is a rod light guide, the light guide body can be formed in cross-section, that is, viewed in the longitudinal extension of the light guide, at least essentially circular with a flattened region. The flattened region can then serve as a surface on which the light decoupling elements or the light decoupling structure are/is disposed. This means that the flattened region of the rod light guide is disposed in the second outer surface, or forms the second outer surface. If the light guide body is a flat light guide, the light guide body can be formed as a plate-shaped light guide that has a significantly greater extension in its length and width, that is, in the plate plane, than in its thickness direction. The light guide body then includes the first outer surface and the second outer surface as a respective flat side, in which the light coupling surface of the light guide body then, for example, is formed as an end side of the plate-shaped light guide body.

The light guide body can have a varying width and/or a varying depth and/or a varying thickness. By varying the corresponding dimensions, it is possible, for example, to achieve a homogeneous light effect. For example, it is possible that the width decreases with increasing distance from a light source or with increasing distance from the light coupling surface. In addition, it is possible that the first outer surface that is facing the user or viewer is formed unevenly or different from a planar surface. For example, the first outer surface of the light guide body can appear to the viewer as a curved surface. The same applies in an analogous manner for the cover element. This means that the lighting device, in particular its light guide body, can appear as a three-dimensionally curved body.

Further advantages, features, and details of the present disclosure can arise from the following description of possible exemplary variations as well as with reference to the drawings. The features and features combinations mentioned above in the description, as well as the features and feature combinations shown below in the Figure description and/or in the Figures alone are usable not only in the respective combination specified, but also in other combinations or alone without departing from the context of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic cross-sectional view of a lighting device in accordance with the teachings of the present disclosure;

FIG. 2 shows a schematic and cross-sectional view of the lighting device in further design in accordance with the teachings of the present disclosure;

FIG. 3 shows a schematic view of the lighting device in a non-illuminated operating mode (day appearance) in accordance with the teachings of the present disclosure;

FIG. 4 shows a schematic view of the lighting device in an illuminated operating mode (night appearance) in accordance with the teachings of the present disclosure;

FIG. 5 shows a perspective view of the lighting device disposed in an installation position in the non-illuminated operating mode in accordance with the teachings of the present disclosure;

FIG. 6 shows a perspective view of the lighting device disposed in an installation position in the illuminated operating mode in accordance with the teachings of the present disclosure;

FIG. 7 shows a schematic cross-sectional of a light decoupling element in accordance with the teachings of the present disclosure;

FIG. 8 shows a schematic view of a light guide body in accordance with the teachings of the present disclosure; and

FIG. 9 shows an angle function of a light decoupled from the light guide body in accordance with the teachings of the present disclosure.

In the Figures, identical/functionally identical elements are provided with the same reference numbers.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In FIG. 1, a lighting device 1 is depicted in schematic and cut view. The lighting device 1 is provided for a motor vehicle (not depicted), and in one form for an interior of the motor vehicle. The lighting device 1 includes a light guide body 2 that includes a first outer surface 3 and a second outer surface 4. Furthermore, the light guide body 2, which is configured in the present example as a square-shaped and flat light guide body 2, includes a first end surface 5 and a second end surface 6. Here the end surfaces 5, 6 are spaced from each other via a width or via a depth, whereas the outer surfaces 3, 4 are spaced from each other via a thickness or gauge. The first outer surface 3 is also formed as a useful-light exit surface and free from a dedicated light decoupling structure. In contrast, on the second outer surface 4 a dedicated light decoupling structure 7 is disposed that in the present example includes a variety of light decoupling elements 8. Here the light decoupling structure 7 is or the light decoupling elements 8 are, in the present example, formed or disposed only regionally on the second outer surface 4 of the light guide body 2. In this regard, the light guide body 2 in the present case includes a light decoupling region 9 that is characterized by the light decoupling structure 7 or the light decoupling elements 8. Furthermore, the light guide body 2 includes at least one clear region 10 that is characterized by the absence of a light decoupling structure or a light decoupling element.

In the lighting device 1, in particular in the light guide body 2, in the present example it is provided that a light, with a wavelength between approximately 400 nanometers and approximately 780 nanometers (“visible light”) generated by a light source 11 is coupled in the light guide body 2 via a light coupling surface 12. In the present case it is provided that the light coupling surface 12 is formed by one or more of the end surfaces 5, 6. The light coupled in the light guide body 2 is then guided-through in the interior of the light guide body 2 in regions of the light guide body 2 that are free from a light decoupling structure 7 or free from light decoupling elements 8—i.e. in a clear region 10—by total reflection by the light guide body 2. If the light in the interior of the light guide body 2 meets a region of the light guide body 2 in which the light guide body 2 includes a light decoupling structure 7, that is, at least one light decoupling element 8—that is, on a respective light decoupling region 9—at this point the light is decoupled, illustrated as light 13, through the first outer surface 3 from the light guide body 2.

The light decoupling structure 7 formed for the purpose of light decoupling is formed in the light decoupling region 9 only on the second outer surface 4 of the light guide body 2. This means that both in the light decoupling region 9 and in the at least one clear region 10, the first outer surface 3 is free from light decoupling elements or free from a light decoupling region.

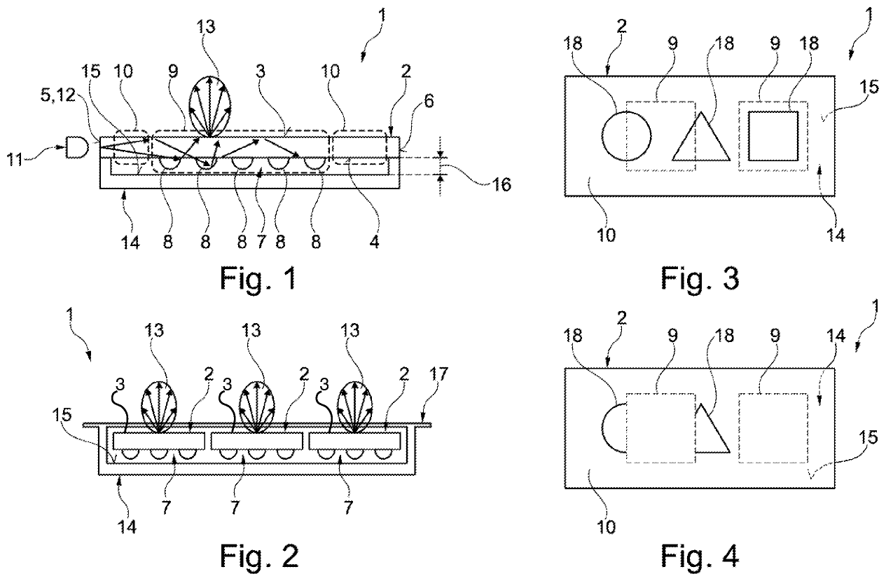

In the light guide body 2, in one form includes at least one clear region 10 and/or more than one light decoupling region 9. Furthermore, it can be provided that the light guide body 2 is formed without a clear region 10, that is, includes only the light decoupling region 9. The lighting device 1 can include such a light guide body 2, or more than one such light guide body 2. Such a lighting device with more than one light guide body 2 is depicted in FIG. 2.

The light decoupling structure 7 is provided such that—when the light is coupled into the light guide body 2 via the light coupling surface 12—the light decoupling region 9 is an opaque region of the light guide body 2. Here the light decoupling structure 7 is provided such that—when no light is coupled into the light guide body 2 via the light coupling surface 12—the light decoupling region 9 is a transparent region of the light guide body 2.

In FIG. 1, it can also be particularly clearly seen that the lighting device 1 is free on the first outer surface 3 from a dedicated opaque or milky light diffusing element, such as a diffusing lens. In other words, no light diffusing element or no diffusing lens is disposed between a viewer of the lighting device 1 and the light guide body 2.

In the present example, the lighting device 1 includes a design carrier 14 with a design surface 15, wherein the second outer surface 4 of the light guide body 2 and the design carrier 14 face each other. Here the second outer surface 4 and the design surface 15 facing the second outer surface 4 are spaced from each other by a spacing 16. In the present example, the spacing 16 is between 0.3 mm and 100 mm. The design carrier 14, in particular the design surface 15, has no reflection function, which means that the design carrier 14 is not an optical reflector element (such as a mirror, etc.).

In FIG. 2, the lighting device 1 is depicted in schematic and cut view, in which the lighting device 1 includes in further design a transparent cover element 17. The transparent cover element 17 is disposed facing the light guide body 2 on the side of the first outer surface 3. Furthermore, the transparent cover element 17 is free from a dedicated light decoupling structure, that is, free from a light decoupling element formed for the purpose of light decoupling or light diversion. For example, the transparent cover element 17 is a clear glass disc, which intentionally has no light-diffusing function. This means that when the cover element is manufactured, no step is taken to confer to the cover element 17 a light-diffusing functionality or property. It can be provided that in the manufacturing of the cover element 17, a step is taken to remove a light-diffusing functionality or property from the cover element 17. This also applies analogously to the first outer surface 3 of the light guide body 2. Consequently, the transparent cover element 17 is formed or inserted in the lighting device 1 so as not to affect light 13 decoupled from the light guide body 2 or the light guide bodies 2. Thus, the clear or transparent cover element 17 is a protective element in order to inhibit objects and/or liquids from intruding into the region between the design surface 15 and the light guide body 2 or the light guide bodies 2.

FIG. 3 shows in schematic view the lighting device 1 in a non-illuminated operating mode, which is also called the day appearance. Here in FIG. 3, a plan view of the lighting device 1 is shown, wherein the design surface 15 carries a design element 18 or a variety of design elements 18. One or more of the design elements 18, can be, for example, a surface structure of the design surface 15, such as a carbon mesh, etc., of symbols, numbers, letters, etc. Since in a non-illuminated operation of the lighting device 1 (see FIG. 3) no light is coupled into the light guide body 2 via the light coupling surface 12, the respective light decoupling region 9 is a transparent region, for the viewer of the lighting device 1, of the light guide body 2 or of the lighting device 1. This is shown in FIG. 3 by the design elements 18 being depicted as recognizable/visible through the light decoupling regions 9. FIG. 4 shows in schematic view the lighting device 1 in an illuminated operating mode, which is also called the night appearance. In the illuminated operating mode, light is coupled into the light guide body 2 via the light coupling surface 12, whereby the light decoupling regions 9 are opaque, for the viewer of the lighting device 1, in illuminated operation or in the day appearance. This is shown in FIG. 4 by the design elements 18, in particular, portions thereof that are disposed below the light guide element 2 in the viewing direction of the viewer toward the lighting device 1 in the region of the light decoupling region 9 not being recognizable for the viewer.

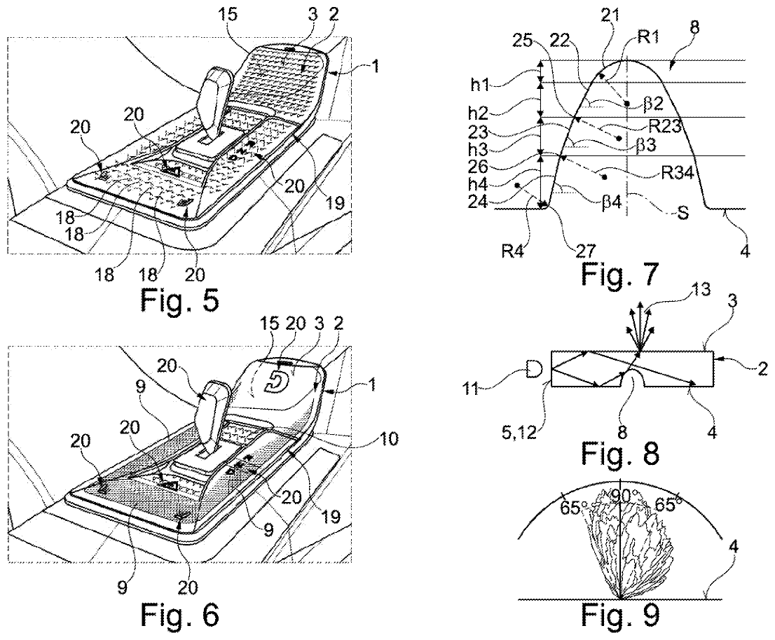

FIG. 5 and FIG. 6 show a use example of the lighting device 1, which is disposed in the installation position. For this purpose, FIG. 5 shows in perspective view the lighting device 1, which is disposed in the installation position, in the non-illuminated operating mode, that is, in the day appearance. From this it is particularly clear that the lighting device 1 can be part of a user interaction unit 19, or that the lighting device 1 includes the user interaction unit 19. In the present example, the user interaction unit 19 includes the light decoupling region 9 or more light decoupling regions 9 as user interaction region 20. Since the light decoupling structure 7 or the light decoupling structures 7 appear as transparent for the viewer in the non-illuminated operating mode or in the day appearance, the design surface 15 and/or possible contours disposed thereon (for example, contours of the design elements 18) are visible through the light guide body 2. Accordingly, light decoupling elements 8 are not drawn in FIG. 5. FIG. 6 shows in perspective view the lighting device 1 disposed in the installation position in the illuminated operating mode, that is, in the night appearance. In contrast to the representation in FIG. 5, it is to be seen in FIG. 6 that the design surface 15 and/or contours or design elements 18 disposed thereon are at least regionally not visible to the viewer due to the opaque light decoupling regions 9 in the illuminated operating mode; the portions of the design surface accordingly covered by the illuminated light decoupling regions 9 are not visible in FIG. 6.

Furthermore, in FIG. 6 the light decoupling region 9 and at least one clear region 10 merge into each other seamlessly. Such a seamless transition between the light decoupling region 9 and the at least one clear region 10 is achieved, for example, by an arrangement density of light decoupling elements 8 decreasing—starting from the light decoupling region 9, which is completely opaque, toward the at least one clear region 10, which is completely transparent, in the illuminated operating mode. This means that there can be at least one region, between the at least one clear region 10 and the light decoupling region 9, that is formed partially transparent or partially opaque. Alternatively, or additionally, it is possible that the light decoupling region 9 and the at least one clear region 10 are sharply delineated from each other, in which no partially transparent or partially opaque region is then disposed between the at least one clear region 10, which is completely clear, and the light decoupling region 9, which is completely opaque.

FIG. 7 shows in schematic and cut view a light decoupling element 8, in which a variety of light decoupling elements 8 form a light decoupling structure 7. The light decoupling element 8 has a symmetrical shape assembled from a plurality of regions. More precisely, viewed in cross-section, the light decoupling element 8 is formed symmetric to a symmetry element, and in one form a symmetry axis S.

The light decoupling element 8 extends, for example, from the second outer surface 4 to the first outer surface of the light guide body 2, through which the light 13 is decoupled from the light guide body 2 when the light guide body 2 is operated in illuminated operating mode (see the light 13 in FIG. 1 and FIG. 2). In other words, the light decoupling element 8 depicted in FIG. 7 is a concave light decoupling element.

In an alternative design, the light decoupling element 8 can extend outward starting from the second outer surface 4 of the light guide body 2, which means that the light decoupling element 8 is then a convex light decoupling element 8. Here, a single one of the possible multiple light decoupling structures 7 can include only convex, only concave, and concave and convex light decoupling elements 8.

A tip region 21 is formed corresponding to a spherical calotte or corresponding to a sphere segment, and thus appears in the cross-section shown in FIG. 7 as circle-arc-shaped or pitch-circle-shaped tip region 21. As can be seen in FIG. 7, the tip region 21 has a radius R1 and a height h1 (in the extension direction of the light decoupling element 8). Furthermore, the tip region 21 is connected to a first linear region 22, which has a height h2. In one form, the height h1 is less than the height h2; thus the height h2 corresponds to approximately two times the height h1, in which the height scaling can also be different, that is, h1 can be greater than h2. The first linear region 22 also further has a first angle of inclination P2, which is spanned between the first linear region 22 and the second outer surface 4 of the light guide body. The angle β2 depicted in FIG. 7 corresponds, for example, to 50°.

The first linear region 22 and a second linear region 23 are connected to each other by a first pitch-circle-shaped connecting region 25, Similarly, the second linear region 23 and a third linear region 24, are connected to each other by a second pitch-circle-shaped connecting region 26. This means that the first pitch-circle-shaped connecting region 25 connects the first linear region 22 and the second linear region 23 to each other. The first pitch-circle-shaped connecting region 25 serves, in one form, to make the transition between the first linear regions 22 and the second linear region 23 “soft.” In the example depicted here, the first pitch-circle-shaped connecting region 25 has a radius R23 of 0.2 mm.

As can be seen in FIG. 7, the second linear region 23 has a height h3 that is greater than the height h2 of the first linear region 22. Furthermore, the second linear region 23 has a second angle of inclination P3, different from the angle of inclination P2, which is spanned between the second linear region 23 and the second outer surface 4 of the light guide body 2. As depicted, the second angle of inclination P3 of the second linear region 23 is greater than the first angle of inclination P2 of the first linear region 22. Here the angle β3 is 55°.

The second linear region 23 and the third linear region 24 are connected to each other via the second pitch-circle-shaped connecting region 26. Here the second pitch-circle-shaped connecting region 26 serves to produce a smooth transition between the second linear region 23 and the third linear region 24. The second pitch-circle-shaped connecting region 6 has a radius R34 of 0.2 mm.

The third linear region 24 has a height h4. The height h4 is, in one form, greater than the height h3; here the height h4 is approximately twice as great as the height h3. Furthermore, the third linear region 24 has a third angle of inclination P4, which is spanned between the third linear region 24 and the second outer surface 4 of the light guide body 2. Here the third angle of inclination P4 is greater than the second angle of inclination P3 of the second linear region 23, and in one form greater than the first angle of inclination P2. The angle β4 depicted here is 60°.

Furthermore, the third linear region 24 is connected to the second outer surface 4 of the light guide body 2 via a third pitch-circle-shaped connecting region 2.

Since the light decoupling element 8 is depicted symmetric in FIG. 7, the regions of the light decoupling element 8 are each located to the left and to the right of the symmetry element S, which can have a symmetry plane and/or a symmetry axis. Under the assumption that the symmetry element S is a rotation symmetry axis, the tip region 21 forms a spherical shape, and the first linear region 22, the second linear region 23 and the third linear region 24 are each truncated-cone-shaped regions. This means that the light decoupling element 8 thus combines a spherical structure with conical structures such that the decoupled light depicted in FIG. 1 or FIG. 2 can be achieved.

FIG. 8 shows a schematic view of the light guide body 2 in cross-section, in which the light guide body 2 includes a light decoupling structure 7 with at least one light decoupling element 8, of which only one of which is depicted in FIG. 8. The light source 11 (for example, an LED) couples light into the light guide body 2. The light is introduced into the light guide body 2 via the light coupling surface 12 (here the end surface 5). In the light guide body 2, the light meets the light decoupling element 8, which extends from the second outer surface 4 of the light guide body 2 into the light guide body 2 and/or projects outward from the second outer surface 4 of the light guide body 2. Using the light decoupling element 8, the light is guided toward and through the first outer surface, so that the light can exit from the light guide body 2 (see light 13). The first outer surface 3 of the light guide body 2 is therefore the light decoupling surface of the light guide body 2.

FIG. 9 shows an angle function, according to which the light 13 is decoupled from the light guide body 2. Here angles are specified with respect to the exit surface (that is, the first outer surface 4) of the light guide body 2. The symmetry element S extends lengthened through the depicted 90° axis.

As shown furthermore in FIG. 3, due to the light guide body 2 with the light decoupling elements 8 in an angle range of 65° to 90° with respect to the exit surface of the light guide body 2, an extremely homogeneous light function, that is, intensity function of the light (Lambert's Law) can be achieved. The intensity has a nearly uniform course with a slight decline at the edge of the angle range. Furthermore, the angle function is symmetric with respect to the 90° axis in the desired angle range. This symmetry brings the further advantage that the angle function of the decoupled light is independent of the propagation direction of the light in the light guide body 2. Thus, a free selection for the light source 11 at the light guide body 2 is possible.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A lighting device for a motor vehicle, the lighting device having a light guide body, wherein the light guide body comprises:
a first outer surface that is free from a dedicated light decoupling structure;
a second outer surface, wherein the first outer surface and the second outer surface are spaced from each other by a thickness of the light guide body;
a light coupling surface;
a light decoupling region, wherein on the second outer surface the dedicated light decoupling structure comprises at least one light decoupling element and is configured such that:
in an illuminated operating mode, when light is coupled into the light guide body via the light coupling surface, the light decoupling region is an opaque region of the light guide body, and
in a non-illuminated operating mode, when no light is coupled into the light guide body via the light coupling surface, the light decoupling region is a transparent region of the light guide body; and
a design carrier with a design surface on which a design element is disposed, wherein the second outer surface of the light guide body and the design surface of the design carrier are facing each other, whereby for a human viewer a portion of the design element covered by the light decoupling region is visible in the non-illuminated operating mode and is not visible in the illuminated operating mode.

2. The lighting device according to claim 1, wherein on a side of the first outer surface no dedicated opaque light diffusing element is disposed.

3. The lighting device according to claim 1, wherein the second outer surface and the design surface of the design element are spaced from each other by a spacing that is up to 100 mm.

4. The lighting device according to claim 3, wherein the spacing between the second outer surface and the design surface of the design carrier varies along a width direction of the light guide body.

5. The lighting device according to claim 3, wherein the spacing between the second outer surface and the design surface of the design carrier varies along a depth direction of the light guide body.

6. The lighting device according to claim 1, further comprising a user interaction unit, wherein the user interaction unit comprises the light decoupling region as a user interaction region.

7. The lighting device according to claim 1, wherein the light guide body defines a flat outer contour.

8. The lighting device according to claim 1, wherein the light guide body comprises a clear region, delineated by the light decoupling region, which is free from a light decoupling structure.

9. The lighting device according to claim 8, wherein the light decoupling region and the clear region are delineated from each other.

10. The lighting device according to claim 8, wherein the light decoupling region and the clear region merge into each other.

11. The lighting device according to claim 1, further comprising a transparent cover element facing the light guide body on a side of the first outer surface, wherein the transparent cover element is free from the dedicated light decoupling structure.

12. The lighting device according to claim 1, wherein the at least one light decoupling element, viewed in cross-section, includes at least one pitch-circle-shaped tip region, a first linear region connected to the pitch-circle-shaped tip region, and a second linear region connected to the first linear region.

13. The lighting device according to claim 12, wherein, in relation to the second outer surface, the first linear region has a first incline, and the second linear region has a second incline.

14. The lighting device according to claim 1, wherein the at least one light decoupling element of the dedicated light decoupling structure extends, starting from the second outer surface, into the light guide body as a material-free region.

15. The lighting device according to claim 1, wherein the at least one light decoupling element of the dedicated light decoupling structure projects outward from the second outer surface.

16. The lighting device according to claim 1, wherein the at least one light decoupling element is symmetric with respect to a symmetry element and disposed perpendicular to the second outer surface.
